(19) United States
(12) Patent Application Publication
(10) Pub. No.: US 2023/0216356 A1
(43) Pub. Date: Jul. 6, 2023

(54) MATERIAL LAYER FOR A LAMINATED CORE OF AN ELECTRIC MACHINE

(71) Applicant: Siemens Aktiengesellschaft, 80333 München (DE)

(72) Inventors: Carsten Schuh, Baldham (DE); THOMAS SOLLER, Deggendorf (DE); ROLF VOLLMER, Gersfeld (DE)

(73) Assignee: Siemens Aktiengesellschaft, 80333 München (DE)

(21) Appl. No.: 18/014,930

(22) PCT Filed: May 17, 2021
(86) PCT No.: PCT/EP2021/062943

§ 371 Date: Jan. 6, 2023

(30) Foreign Application Priority Data
Jul. 8, 2020 (EP) 20184623.5

(51) Int. Cl. H02K 1/04; H02K 15/02

(52) U.S. Cl. CPC H02K 1/04; H02K 15/02; H02K 2215/00

(57) ABSTRACT

A material layer for a laminated core of an electric machine is made of iron-containing ferromagnetic material and includes an electrically insulating coating on at least one side of the material layer. The electrically insulating coating Includes an electrically Insulating material which Is produced through controlled oxidation of the ferromagnetic material of the material layer and contains iron monoxide and/or triiron tetraoxid. The material layer is produced from a green body, which Is sintered under a reducing atmosphere.

The invention relates to a material layer for a laminated core of an electric machine.

Furthermore, the invention relates to a laminated core for an electric machine with a plurality of such material layers.

Moreover, the invention relates to an electric rotating machine with at least one laminated core.

In addition, the invention relates to a method for producing such a material layer.

In electric machines, laminated cores of stacked electrical sheets are customarily used to suppress the propagation of eddy currents. Such electric machines are for example motors, generators and transmitters, such as transformers and switching devices. The electrical sheets, which for example, contain a soft magnetic material, in particular iron, are customarily cut or punched out of rolled large metal sheets. The sheets are then packaged to form a laminated core. It is currently not possible to produce metal sheets on an Industrial scale with a layer thickness of no more than 100 μm by means of such a conventional production method. In addition, waste accrues when cutting or punching out the sheets from the large metal sheets.

The patent application EP 3 595 148 A1 describes a method for producing a material layer having a layer thickness between 0.5 and 500 μm, comprising the steps: applying a suspension, having at least one binder and solid particles, through a stencil to a base area to obtain a green body, expelling the binder from the green body, in particular, by means of debindering, creating a permanent cohesion of the solid particles by heating and/or by means of compaction, in particular, by means of sintering.

In addition, a treatment and functionalization of the surfaces is required in order to electrically insulate individual sheets from one another during the construction of sheet stacks. Electrical sheets produced by a conventional production method are customarily coated with an Insulating lacquer having a typical layer thickness of 1 to 4 μm, which, in particular in the case of very thin electrical sheets having a layer thickness of at most 100 μm, constitutes significant additional time and expense. In addition, in the case of such thin electrical sheets, the magnetically Inactive lacquer layer takes up a proportionally significant share of the total sheet thickness and thereby noticeably reduces the stacking factor and thus the performance of the electric machine.

The object of the invention is to provide a material layer for a laminated core of an electric machine which, in comparison with the prior art, can be produced more simply and economically and allows a greater stacking factor.

The object is achieved according to the Invention by a material layer for a laminated core of an electric machine which is produced from a ferromagnetic material and has an electrically insulating coating on at least one layer side, the electrically insulating coating comprising an electrically Insulating material and the electrically Insulating material of the electrically insulating coating being produced by means of controlled oxidation of the ferromagnetic material of the material layer.

Furthermore, the object is achieved according to the invention by a laminated core for an electric machine having a plurality of such material layers.

Moreover, the object is achieved according to the invention by an electric rotating machine having at least one laminated core.

In addition, the object is achieved according to the invention by a method for producing a material layer for a laminated core of an electric machine, a green body being produced from a ferromagnetic material, the green body being sintered, an electrically insulating coating being produced on at least one layer side by means of controlled oxidation of the ferromagnetic material of the material layer Immediately after the sintering process.

The advantages and preferred embodiments listed hereinafter with regard to the material layer can be applied analogously to the laminated core, the electric machine and the method.

The invention is based on the consideration of Increasing a stacking factor in a laminated core for an electric machine by reducing the layer thickness of insulation between the material layers. Such material layers are produced from a ferromagnetic material. Ferromagnetic materials are, for example, iron and iron alloys, in particular, iron-based alloys. Iron-based alloys are, for example, Iron cobalt and iron silicon. Such insulation is designed as an electrically insulating coating and is arranged on at least one layer side, the electrically insulating coating comprising an electrically insulating material. Electrically insulating materials are, for example, Iron oxides, in particular, iron monoxide (FeO, also referred to as iron(II) oxide), triiron tetraoxide (Fe₃O₄, also referred to as iron(II,III) oxide or magnetite) and diiron trioxide (Fe₂O₃, also referred to as iron(III) oxide). The electrically insulating coating is produced by oxidizing the ferromagnetic material of the material layer in a controlled manner. Controlled oxidation takes place in an enclosed area with a controlled atmosphere. This means that a defined oxygen partial pressure Is set for controlled oxidation, in a predetermined temperature range in which the oxygen partial pressure is available, over a defined period of time. In this way, a desired composition and layer thickness of the electrically insulating coating can be produced in a simple and economical manner via a defined redox potential. Furthermore, very thin layers, for example thinner than 1 μm, can be produced by means of controlled oxidation, which increases the stacking factor in the laminated core.

A further embodiment provides that the ferromagnetic material has an electrical conductivity of at least 8 MS/m. For example, the ferromagnetic material is iron or an iron alloy. Experience shows that such conductivity has proven to be particularly advantageous.

A further embodiment provides that the ferromagnetic material contains iron, the electrically insulating material containing an iron oxide, in particular, iron monoxide and/or triiron tetraoxide. Due to its metallurgical properties, iron is well suited for the production of thin sheets. Furthermore, iron can be oxidized simply and economically in a controlled manner, it being possible for thin oxide layers to be produced by means of controlled oxidation, which allow a large stacking factor.

A further embodiment provides that the electrically insulating material of the electrically Insulating coating has a ferrimagnetic material and/or a permeability of at least 3. A ferrimagnetic material is, for example, triiron tetraoxide. The magnetic volume of the laminated core Is Increased by such insulation.

A further embodiment provides that the electrically insulating coating has a layer thickness of at most 1 μm. As a result of such a small layer thickness, a sufficiently high stacking factor is achieved even in the case of thin metal sheets.

A further embodiment provides that the material layer has a layer thickness of 10 μm to 150 μm, in particular, 10 μm to 100 μm. In the case of such a layer thickness, sufficient eddy current suppression is achieved, for example when used in an electric machine.

A further embodiment provides that the material layer is produced from a green body. The green body is produced, for example, by means of screen printing, stencil printing or binder Jetting. In particular, the green body has a binder, in particular an organic binder, and ferromagnetic solid particles, the ferromagnetic solid particles being present, for example, as alloy powders or as mixtures of powders of pure elements. The powder can be adapted in terms of strength, magnetic and/or electrical properties, thermal conductivity and type of oxidation product.

A further embodiment provides that the material layer has the electrically insulating coating on both layer sides. Insulation on both sides increases the reliability, in particular in the case of thin insulation layers.

A further embodiment provides that the green body is sintered under a reducing atmosphere. A reducing atmosphere contains, for example, a hydrogen-nitrogen mixture or a hydrogen-noble gas mixture, in particular, a hydrogen-argon mixture. The nitrogen or the noble gas act as purge gas. For example, the green body is sintered under a forming gas containing 95% nitrogen and 5% hydrogen. Oxidation and thus Impurities are prevented by the reducing atmosphere. In particular, organic binders are expelled essentially without residue in a reducing atmosphere by removing the carbon atoms from the green body.

A further embodiment provides that a redox potential for the controlled oxidation of the ferromagnetic material is set in a targeted manner by adding water vapor. The targeted setting of the redox potential takes place, for example, via a concentration of the water vapor in the atmosphere at a defined temperature. Oxidation through the addition of water vapor is simple and economical, in particular immediately after sintering under a reducing atmosphere.

A further embodiment provides that the at least one layer side is oxidized in a controlled manner by setting an oxygen partial pressure, a temperature range in which the oxygen partial pressure is available, and a period of time. For example, at a given oxygen partial pressure and a given temperature at which the oxygen partial pressure is available, the layer thickness is essentially set by the period of time, while the composition of the oxide layer being formed is essentially controlled by the oxygen partial pressure and the temperature range in which the oxygen partial pressure is available. By varying the parameters, oxide layers of the desired type and layer thickness can be produced simply and economically.

A further embodiment provides that the ferromagnetic material contains iron, the oxygen partial pressure, the temperature range in which the oxygen partial pressure is available, and the period of time being set in such a way that the electrically insulating material contains a predetermined proportion of iron monoxide and/or triiron tetraoxide. In this way, iron oxide layers of the desired type and layer thickness can be produced simply and economically.

The invention is described and explained in more detail hereinafter with reference to the exemplary embodiments shown in the figures, in which:

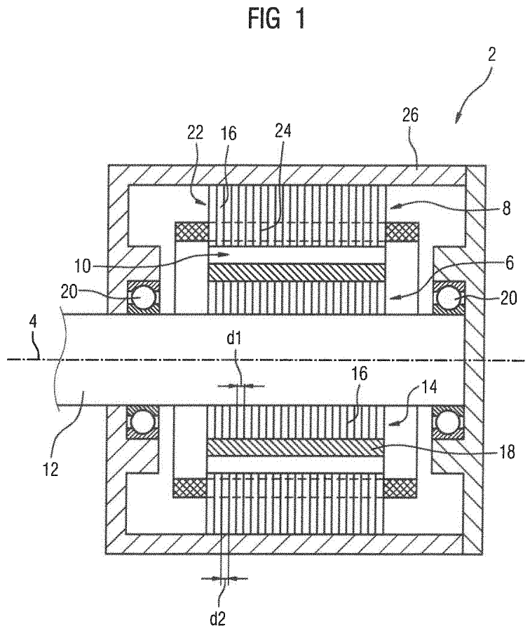

FIG. 1 shows a schematic cross-sectional representation of an electric rotating machine,

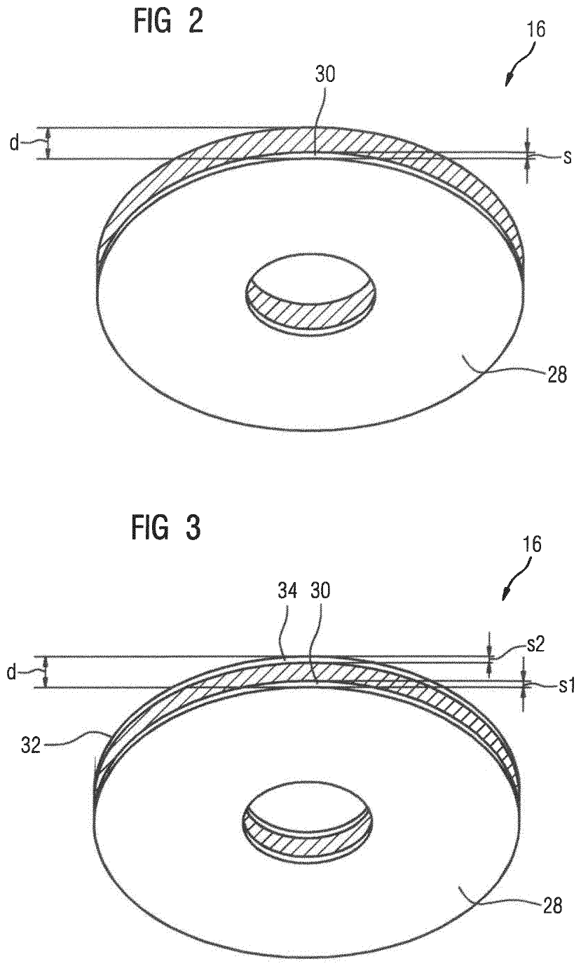

FIG. 2 shows a schematic representation of a first embodiment of a material layer,

FIG. 3 shows a schematic representation of a second embodiment of a material layer,

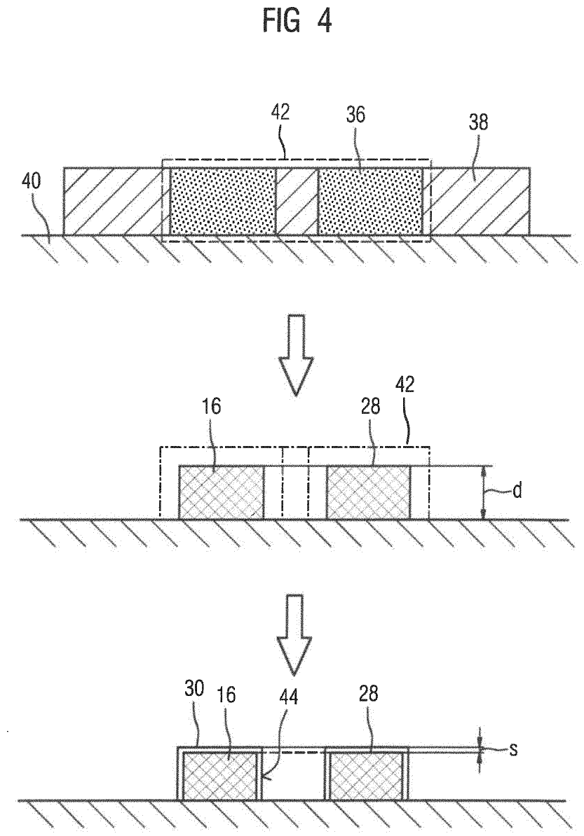

FIG. 4 shows a schematic representation of a method for producing a material layer,

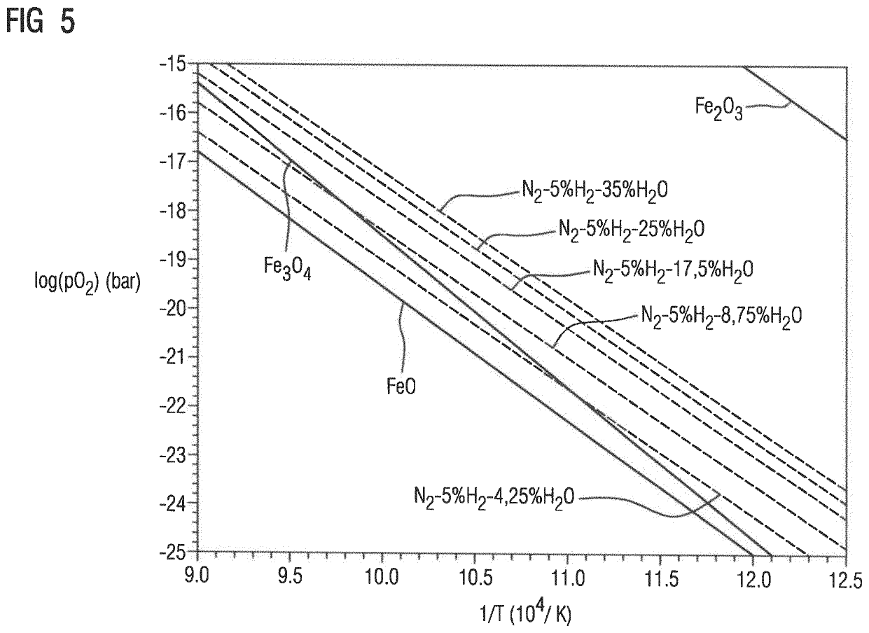

FIG. 5 shows a thermodynamic state diagram for various iron oxides and

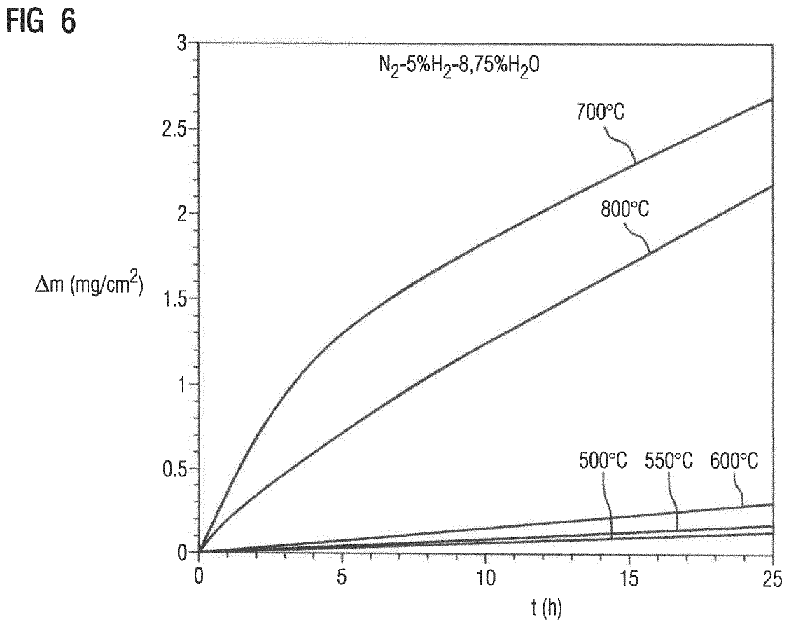

FIG. 6 shows isothermal oxidation kinetics curves for iron as a function of time and temperature.

The exemplary embodiments explained hereinafter are preferred embodiments of the invention. In the exemplary embodiments, the described components of the embodiments each represent Individual features of the invention which are to be considered independently of one another and which each also develop the invention independently of one another and are thus also to be regarded as part of the invention individually or in a combination other than that shown. Furthermore, the described embodiments can also be supplemented by further features of the Invention already described.

Identical reference characters have the same meaning in the different figures.

FIG. 1 shows a schematic cross-sectional representation of an electric rotating machine 2. The electric rotating machine 2, which can be used as a motor and/or as a generator, has a rotor 6, which can be rotated about an axis of rotation 4, and a stator 8, the stator 8 being arranged, for example, radially outside the rotor 6. The axis of rotation 4 defines an axial direction, a radial direction and a circumferential direction. A fluid gap 10, which is designed in particular as an air gap, is formed between the rotor 6 and the stator 8.

The rotor 6 has a shaft 12 and a rotor laminated core 14, the rotor laminated core 14 being connected to the shaft 12 in a rotationally fixed manner. The rotor laminated core 14 comprises a multiplicity of stacked material layers 16 which are electrically insulated from one another and have a first layer thickness d1 in the range of 10 μm to 150 μm, in particular, 10 μm to 100 μm, and are produced from a ferromagnetic material, for example from iron or an iron alloy. In addition, the rotor 6 comprises a plurality of permanent magnets 18 connected to the rotor laminated core 14 for operation as a synchronous machine. The rotor 6 can have, in particular instead of the permanent magnets 18, a short-circuit cage for operation as an asynchronous machine or an excitation winding. The shaft 12 of the rotor 6 is rotatably arranged over bearings 20.

The stator 8 comprises a laminated stator core 22 in which a stator winding 24 is accommodated. The laminated stator core 22 comprises a multiplicity of stacked material layers 16 which are electrically insulated from one another and have a second layer thickness d2 in the range of 10 μm to 150 μm, in particular, 10 μm to 100 μm, and are produced from a ferromagnetic material, for example from iron or an iron alloy. The rotor 6 and the stator 8 are accommodated in an enclosed housing 26.

FIG. 2 shows a schematic representation of a first embodiment of a material layer 16 which has a layer thickness d in the range of 10 μm to 150 μm, in particular, 10 μm to 100 μm, and is produced, for example, by means of screen printing, stencil printing or binder jetting and subsequent sintering. The material layer 16 in FIG. 2 can be configured for a rotor laminated core 14 or a laminated stator core 22 and is produced from a ferromagnetic material, for example from iron or an iron-based alloy, with an electrical conductivity of at least 8 MS/m. A layer side 28 of the material layer 16 has an electrically insulating coating 30 which is suitable for electrically insulating stacked material layers 16 from one another, for example when used in a laminated core 14, 22. The electrically insulating coating 30 is produced from an electrically insulating material, the electrically insulating material having a conductivity which is at least 1000 times less than the conductivity of the ferromagnetic material. In addition, the electrically insulating coating 30 has a layer thickness s1 of at most 1 μm.

The electrically insulating coating 30 is produced by means of controlled oxidation of the ferromagnetic material of the material layer 16. In the case of controlled oxidation, a composition of the electrically Insulating coating 30 and the layer thickness s are set via a defined redox potential. In this case, the surface of the material layer 16 is oxidized over a defined period of time under a defined oxygen partial pressure in a predetermined temperature range in which the oxygen partial pressure is available. The composition and layer thickness s of the oxide layer forming can thus be controlled by the composition of the atmosphere, the temperature and the period of time.

In the case of a material layer 16 produced from iron, the surface of the material layer 16 is oxidized with the aid of water vapor, it being possible to adjust the type and thickness of the oxide layer via a proportion of the water vapor in the atmosphere. In this case, the electrically insulating material iron monoxide (FeO) and/or triiron tetraoxide (Fe₃O₄) is produced, the proportions of the iron oxides being able to be controlled via the composition of the atmosphere, the temperature and the period of time.

In particular, the electrically insulating material of the electrically Insulating coating 30 has a permeability of at least 3, the permeability of the electrically insulating material being able to be controlled via its composition. The further embodiment of the material layer 16 in FIG. 2 corresponds to the embodiment in FIG. 1.

FIG. 3 shows a schematic representation of a second embodiment of a material layer 16 which has an electrically insulating coating 30, 34 on both layer sides 28, 32. A first layer thickness s1 is formed on the first layer side 28, while a second layer thickness s2 is formed on the second layer side 32. For example, the first layer thickness s1 corresponds to the second layer thickness s2. The further embodiment of the material layer 16 in FIG. 3 corresponds to the embodiment in FIG. 2.

FIG. 4 shows a schematic representation of a method for producing a material layer 16. In a method step, a suspension 36, which comprises at least one, in particular organic, binder and ferromagnetic solid particles, in particular Iron particles, is applied through a stencil 38 to a base area 40 to obtain a green body 42. For example, the suspension 36 is applied by means of a doctor blade via the stencil 38, which can have a screen, to the base area 40. Alternatively, the green body 42 is produced by means of binder Jetting.

In a subsequent method step, the binder is driven out of the green body 42, In particular, by means of debindering, and the green body 42 is sintered, the sintering process creating a permanent cohesion of the ferromagnetic solid particles. Sintering and debindering takes place in an enclosed area with a controlled atmosphere. The green body 42 is debindered and sintered under a reducing atmosphere. The reducing atmosphere contains, for example, a hydrogen-nitrogen mixture or a hydrogen-noble gas mixture, in particular, a hydrogen-argon mixture. The nitrogen or the noble gas act as purge gas. For example, the green body 42 is sintered under a forming gas containing 95% nitrogen and 5% hydrogen. Oxidation and thus Impurities are prevented by the reducing atmosphere. In particular, organic binders are driven out essentially without residue in a reducing atmosphere by removing the carbon atoms from the green body. Both during debindering and sintering, the dimensions of the green body 42 are reduced as a function of the material used, so that the material layer 16 produced by the sintering process has a layer thickness d of 10 μm to 150 μm, in particular, 10 μm to 100 μm.

In a subsequent method step, an electrically insulating coating 30 is produced by means of controlled oxidation of the ferromagnetic material of the material layer 16. The production of the electrically insulating coating 30 by means of oxidation takes place in an enclosed area with a controlled atmosphere. In particular, the production of the electrically insulating coating 30 takes place in the same enclosed area as the sintering process. At least part of the surface 44 of the material layer 16, which is in fluid connection with the atmosphere surrounding the material layer 16, is oxidized over a defined period of time under a defined oxygen partial pressure, in a predetermined temperature range in which the oxygen partial pressure Is available. The layer thickness s is essentially set by the period of time at a given composition of the atmosphere and temperature. The composition of the oxide layer which forms can essentially be controlled by the oxygen partial pressure and the temperature range in which the oxygen partial pressure is available. In particular, the material layer 16 is produced from iron, the surface 44 of the material layer 16 being oxidized with the aid of water vapor in the atmosphere. Two-sided oxidation is made possible, for example, by turning the material layer 16. The further embodiment of the material layer 16 in FIG. 4 corresponds to the embodiment in FIG. 2.

FIG. 5 shows a thermodynamic state diagram for various iron oxides. The thermodynamic state diagram shows the respective oxygen partial pressure pO₂ as a function of the reciprocal temperature T and the proportion of water vapor In an H₂-H₂O atmosphere, the atmosphere containing nitrogen, hydrogen and water vapor. Furthermore, the decomposition pressures of various iron oxides (FeO, Fe₃O₄, Fe₂O₃) are shown as a function of the reciprocal temperature T. The decomposition pressure, which is also referred to as dissociation pressure or formation pressure, Indicates the oxygen partial pressure at precisely which an equilibrium prevails between an oxidation of the metal to the metal oxide and a reduction of the metal oxide to the metal. If the oxygen partial pressure pO₂ In the atmosphere is greater than the decomposition pressure of the respective metal, oxidation takes place. If, for example, the oxygen partial pressure pO₂ is greater than the decomposition pressure of Fe₃O₄, Fe₃O₄ is stable, but if it is smaller, the oxygen-depleted compound FeO is formed. If the oxygen partial pressure pO₂ at a certain temperature is identical to the decomposition pressure, then two solid phases, e.g. FeO and Fe₃O₄, coexist with one another. Therefore, with the method shown in FIG. 4, It is possible to adjust which oxides form in the electrically Insulating coating 30 via the oxygen partial pressure and the temperature range in which the oxygen partial pressure is available.

FIG. 6 shows isothermal oxidation kinetics curves for iron as a function of time t and temperature T. A weight increase Δm of iron oxides as a function of time t and temperature T is shown in a defined atmosphere. Therefore, with the method shown in FIG. 4, a defined layer thickness s can be formed for a given atmosphere by varying the time t and temperature T.

In summary, the invention relates to a material layer 16 for a laminated core 14, 22 of an electric machine 2. In order to allow simpler and more economical production and a greater stacking factor in comparison with the prior art, it is proposed that the material layer 16 is produced from a ferromagnetic material and has an electrically insulating coating 30, 34 on at least one layer side 28, 32, the electrically insulating coating 30, 34 comprising an electrically Insulating material, the electrically insulating material of the electrically Insulating coating 30, 34 being produced by means of controlled oxidation of the ferromagnetic material of the material layer 16.

What is claimed is:

1.-15. (canceled)

16. A material layer for a laminated core of an electric machine, said material layer made of iron-containing ferromagnetic material and comprising:
an electrically insulating coating on at least one side of the material layer, said electrically Insulating coating comprising an electrically insulating material which is produced through controlled oxidation of the ferromagnetic material of the material layer and contains iron monoxide and/or triiron tetraoxide,
wherein the material layer is produced from a green body, which is sintered under a reducing atmosphere.

17. The material layer of claim 16, wherein the ferromagnetic material has an electrical conductivity of at least 8 MS/m.

18. The material layer of claim 16, wherein the electrically insulating material of the electrically insulating coating Includes a ferrimagnetic material and/or a permeability of at least 3.

19. The material layer of claim 16, wherein the electrically insulating coating has a layer thickness of at most 1 μm.

20. The material layer of claim 16, wherein the material layer has a layer thickness of 10 μm to 150 μm, in particular, 10 μm to 100 μm.

21. The material layer of claim 16, further comprising a further electrically insulating coating arranged on another side of the material layer.

22. A laminated core for an electric machine, said laminated core comprising a plurality of material layers, each said material layer comprising an electrically insulating coating on at least one side of the material layer, said electrically insulating coating comprising an electrically Insulating material which is produced through controlled oxidation of the ferromagnetic material of the material layer and contains iron monoxide and/or triiron tetraoxide, wherein the material layer is produced from a green body, which is sintered under a reducing atmosphere.

23. An electric rotating machine, comprising a laminated core as set forth in claim 22

24. A method for producing a material layer for a laminated core of an electric machine, said method comprising:
producing a green body from a ferromagnetic material;
sintering the green body under a reducing atmosphere; and
applying immediately after sintering an electrically insulating coating on at least one layer side through controlled oxidation of the ferromagnetic material.

25. The method of claim 24, further comprising setting a redox potential for the controlled oxidation of the ferromagnetic material by adding water vapor.

26. The method of claim 24, wherein the at least one layer side is oxidized in a controlled manner by setting an oxygen partial pressure, a temperature range in which the oxygen partial pressure is available, and a period of time.

27. The method of claim 26, wherein the ferromagnetic material contains iron, and wherein the oxygen partial pressure, the temperature range in which the oxygen partial pressure is available, and the period of time are set in such a way that the electrically insulating material contains a predetermined proportion of iron monoxide and/or triiron tetraoxide.
